(19) United States
(12) Patent Application Publication
(10) Pub. No.: US 2026/0208884 A1
(43) Pub. Date: Jul. 23, 2026

(54) SPACECRAFT COMBINING SOLAR-THERMAL COLLECTOR, SOLAR-THERMAL ROCKET AND PHOTOVOLTAIC ARRAY IN A COMPACT ASSEMBLY

(71) Applicant: Trans Astronautica Corporation, Lake View Terrace, CA (US)

(72) Inventors: Hayden Andrew Burgoyne, Lake View Terrace, CA (US); Richard Roberts Rieber, Altadena, CA (US); Joel C. Sercel, Sonoita, AZ (US)

(21) Appl. No.: 19/139,191

(22) PCT Filed: Dec. 14, 2023
(86) PCT No.: PCT/US2023/084132

§ 371 Date: Jun. 13, 2025

Related U.S. Application Data
(60) Provisional application No. 63/387,928, filed on Dec. 16, 2022.

(51) Int. Cl. B64G 1/44; B64G 1/00; B64G 1/22; B64G 1/40

(52) U.S. Cl. CPC B64G 1/446; B64G 1/008; B64G 1/2222; B64G 1/411; B64G 1/443

(57) ABSTRACT

Spacecraft combining solar-thermal collector, solar-thermal rocket and photovoltaic array in a compact assembly are provided. In one aspect, a spacecraft includes a spacecraft bus, a rocket thruster, a solar energy collecting mirror, and a photovoltaic panel. The rocket thruster, the solar energy collecting mirror, and the photovoltaic panel are connected together and configured to rotate along a common rotation axis which in turn is attached to a single location on an outer surface of the spacecraft bus.

### INCORPORATION BY REFERENCE TO ANY PRIORITY APPLICATIONS

This application is based upon and claims the benefit of priority from U.S. Provisional Patent Application No. 63/387,928 filed on Dec. 16, 2022. Moreover, any and all applications for which a foreign or domestic priority claim is identified in the Application Data Sheet as filed with the present application are hereby incorporated by reference under 37 CFR 1.57. The entire contents of each of the above-listed items is hereby incorporated into this document by reference and made a part of this specification for all purposes, for all that each contains.

### BACKGROUND

### Field

Aspects of this disclosure relate to systems and methods for constructing folding structures on spacecraft.

### Related Technology

Spacecraft are typically launched from Earth on powerful rockets. Due to the amount of energy required to launch rockets into orbit, it can be important to design spacecraft and other payloads to make efficient use of the rocket's available energy.

### SUMMARY

In some embodiments, there is described a method of launching a spacecraft designed for free-flight in space. The method can comprise: launching the spacecraft from Earth on a rocket, wherein the spacecraft is folded into a compact package in order to fit within an aerodynamic nose fairing atop the rocket during launch; after arriving at a suitable orbit, detaching the spacecraft from the rocket; and unfolding the spacecraft and deploying various structures including solar energy collecting mirrors, photovoltaic arrays, antennas, and thermal radiators.

In some embodiments, there is described a spacecraft comprising: a spacecraft bus; a rocket thruster; a solar energy collecting mirror; and a photovoltaic panel, wherein the rocket thruster, the solar energy collecting mirror, and the photovoltaic panel are connected together and configured to rotate along a common rotation axis which in turn is attached to a single location on an outer surface of the spacecraft bus. In the spacecraft, elements of the solar energy collecting mirror, the photovoltaic panel, the rocket thruster, and the common rotation axis mechanisms can be configured to be compactly folded together during launch operations and unfolded during spacecraft free flight operations. The rocket thruster, the solar energy collector, and the photovoltaic panel can be configured to be actuated by one or more independently controlled rotation motors which allow independent rotation of one or more of the connected elements about the common rotation axis. The spacecraft can further comprise: a second rocket thruster; a second solar energy collecting mirror; and a second photovoltaic panel. The second rocket thruster, the second solar energy collecting mirror, and the second photovoltaic panel can be attached to a second single location on the outer surface of the spacecraft bus. The rocket thruster can comprise a solar thermal rocket. The solar energy collecting mirror can be configured to capture heat energy to power the rocket thruster from sunlight. The spacecraft can further comprise one or more curved mirrors or lenses configured to collect and focus sunlight from the solar energy collecting mirror into a concentrated solar energy beam which is directed along the common rotation axis and into the rocket thruster as the rocket thruster rotates relative to the spacecraft bus and relative to the pointing direction of the solar energy collecting mirror. The spacecraft can further comprise a flexible bundle of optical fibers configured to receive concentrated solar energy and conduct the solar energy into the rocket thruster independent of a relative rotation angle between the solar energy collecting mirror and a pointing direction of the rocket thruster.

### BRIEF DESCRIPTION OF THE DRAWINGS

FIG. 1 illustrates a spacecraft bus utilizing a single large solar energy collecting mirror and two solar thermal thrusters.

FIG. 2 illustrates a solar energy collecting mirror attached to each of multiple solar thermal thrusters.

FIG. 3 illustrates a combined photovoltaic array, a solar energy collector, and a solar thermal thruster.

FIG. 4 illustrates a solar energy collector with an optical fiber energy transmission means.

### DETAILED DESCRIPTION

Space mining and related technology can include vehicles and equipment to extract, process, and store material derived from planetary bodies such as asteroids and the moon. Such materials can be used as propellants, feedstocks for manufacturing, radiation shielding, as a source of resupply of other expendable materials, and/or for return to Earth for use and sale. Vehicles such as spacecraft can be used at various points in this mining effort, including to convey equipment to and from mining locations. Such vehicles can advantageously use the mined materials for propulsion. In particular, spacecraft can heat materials without requiring combustion; solar-powered spacecraft can be useful for this purpose, and can use diverse propellant types. Solar-powered spacecraft may be designed for free flight in space but use other means (e.g., a combustion rocket or other delivery system) to initially escape Earth orbit.

A spacecraft designed for free flight in space is typically launched from Earth on a powerful rocket. During launch, the craft can be folded into a compact package in order to fit within an aerodynamic nose fairing atop the rocket, thereby enabling or facilitating spacecraft that have a deployed size that is larger than the rocket nose to be launched by the rocket. After arriving at a suitable orbit, the free-flying spacecraft detaches from its launch vehicle. The spacecraft may then unfold and deploy various large structures such as solar energy collecting mirrors, photovoltaic arrays, antennas and thermal radiators. For example, by using a foldable design for the spacecraft, the spacecraft can be folded into a package that fits within the nose fairing atop the rocket and can be deployed by simply unfolding the spacecraft, and thus, it is not necessary to assemble the spacecraft after reaching orbit.

Often, it is desirable for the spacecraft to carry additional payloads such as cameras, rocket thrust motors, articulating arms, or ride-along deployable payloads. These multiple structures can be attached to external surfaces on the spacecraft core vehicle, also known as the spacecraft bus. It is desirable to avoid conflict between these many structures both during deployment and during routine operation of the spacecraft. It is also desirable to minimize the number of structures that directly attach to the limited available external surfaces of the spacecraft bus.

Aspects of this disclosure provide for two or more solar-thermal rocket thrusters which may be rotated to point in various useful directions to provide maneuvering capability to the spacecraft without the thrusters'exhaust thrust plumes impinging on nearby spacecraft components.

Further aspects of this disclosure provide for relatively large solar-collecting mirrors to concentrate solar energy into powerful energy beams. The collected energy beams are directed into the solar-thermal rocket thrusters to provide heat energy to power the rocket thrusters. The solar-collecting mirrors are aimed by mechanical means (e.g., to persistently point toward the Sun) while the rocket thrusters and spacecraft bus may be simultaneously pointed in various (e.g., other) useful directions.

Further aspects of this disclosure provide for the solar-collecting mirrors to be attached coaxially along the rotation axis and on the spacecraft in a position generally outboard of the rotating rocket thrusters. A single mirror and its associated rotating rocket thruster are mechanically combined to attach to a single surface on the spacecraft bus. The rocket thruster may be rotated to provide thrust in useful directions. Rocket exhaust plumes do not impinge on the attached solar collecting mirror or any other spacecraft components. The attached solar mirror can continue to point at the Sun independent of rocket thruster pointing direction.

Further aspects of this disclosure provide for photovoltaic solar panels to be attached to the solar-collecting mirrors. The solar panels and the collecting mirrors can be configured to point directly at the Sun, independent of the orientation of rocket thrusters and the spacecraft bus.

These and other features and advantages of the present disclosure will be apparent to those skilled in the art from the present detailed description, taken together with the accompanying drawings, in which like reference numerals refer to like parts.

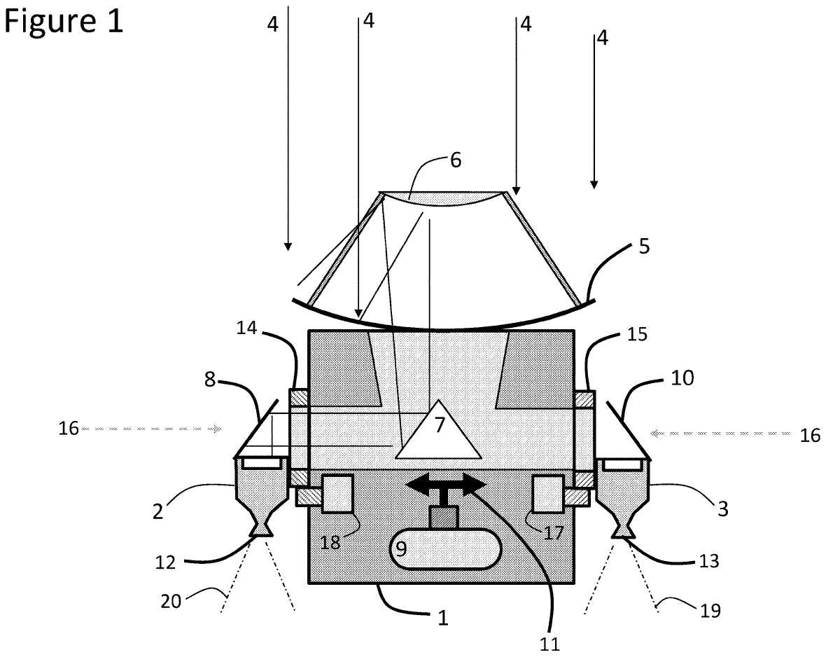

Referring to FIG. 1, a spacecraft bus 1 uses solar thermal rocket thrusters 2 and 3 to maneuver in space. Incoming solar energy from the Sun, shown as multiple rays 4, are reflected and focused into a converging energy beam by a relatively large solar collecting reflector 5. In some embodiments, the reflector 5 may have a diameter that is substantially the same size as or larger than a width of the spacecraft bus 1 and the diameter of the reflector 5 may be smaller than a distance between the rocket thrusters 2 and 3. Additional optical elements 6, 7, 8, and 10 further concentrate the energy beam and/or direct it into the thrusters 2 and 3. A liquid or gaseous propellant contained in internal tank 9 can be distributed for injection into the thrusters by piping 11. For simplicity, details of the piping 11 are not shown. However, the piping 11 can be directed to areas where it (or materials within it) retains, absorbs and/or disperses energy, for example. Heat energy from the concentrated solar energy beam can be transferred to the propellant within the thrusters 2 and 3. The resultant pressurized and high temperature gas can be expelled through rocket nozzles 12 and 13 to produce rocket thrust.

FIG. 1 further shows that the thrusters 2 and 3 are attached to direction modules. In the illustrated embodiment, the direction modules are in the form of rotation rings 14 and 15. The thrusters 2 and 3 and optical elements 8 and 10 are free to rotate independently about a common rotation axis 16. In this manner, the concentrated solar energy beam can deliver uninterrupted energy to the thrusters over all (or substantially all) rotation angles. The rings can be rotated by electric motors 17 and 18, e.g., when commanded by a controller (such as a spacecraft on-board controller). The thruster rotations are advantageously designed such that rocket plumes 19 and 20 do not harmfully impinge on any spacecraft structures during thrusting operations.

It can be seen in FIG. 1 that several external surfaces of the spacecraft bus 1 can be used to attach the solar energy collector and the multiple thrusters. The limited area of external surfaces is also in high demand for other uses, not shown, such as photovoltaic solar arrays, communication antennas, radar and optical sensors, docking and release mechanisms, robotic arms, and/or customer ride-along packages. It is desirable to minimize the number of surface attachment locations for solar thermal thruster systems.

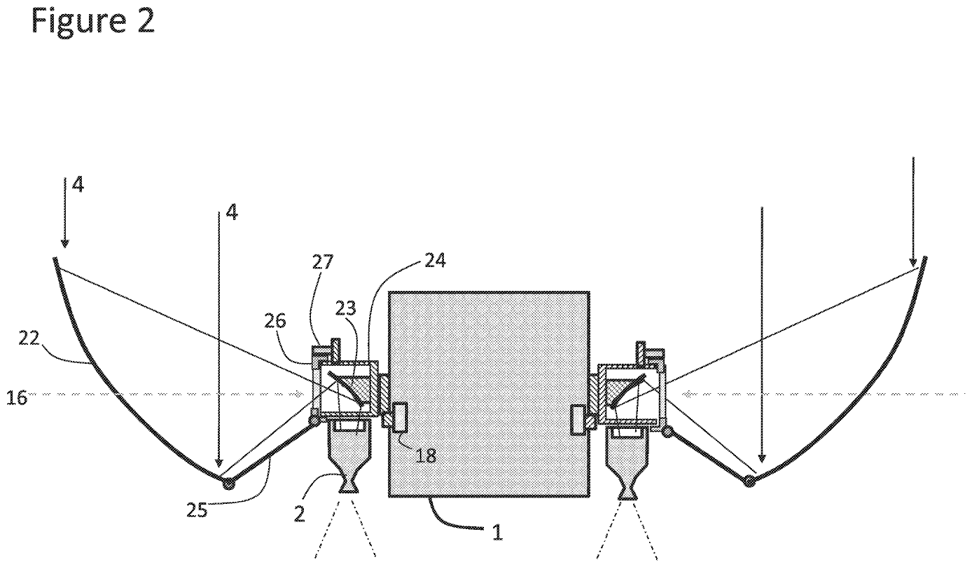

Referring to FIG. 2, a relatively large solar energy collecting reflector 22 is attached directly to thruster 2. For simplicity and because of left-right symmetry, only components on the left side of FIG. 2 are labeled. Incoming solar energy from the Sun, shown as multiple rays 4, is focused into a converging solar energy beam and is reflected toward reflecting optical element 23. Reflector 23 is centered on rotation axis 16. Thruster 2 and reflector 23 rotate together and are fixed to the inside surface of hollow rotating cylinder 24. Cylinder 24 may be rotated around rotation axis 16 by electric motor 18 when commanded by the spacecraft internal controller. Rotation of cylinder 24 allows the thruster to be pointed in various useful directions.

Referring further to FIG. 2, the solar energy collecting reflector 22 is attached by one or more connecting struts 25 to a rotating ring 26. Ring 26 rotates independently of cylinder 24. The ring 26 may rotate with respect to or against either the outer or the inner surface of cylinder 24. FIG. 2 illustrates an outer surface configuration. Electric motor 27 powers the rotation of the ring 26 and its connected reflector 22 with respect to the outer surface of cylinder 24. Thus, whenever the cylinder 24 rotates to position the thruster 2 in a useful direction, the ring 26 may be counter rotated to maintain alignment of the mirror 22 with the Sun. In this manner, the collecting mirror 22 does not require an independent attachment to the outer surface of the spacecraft bus 1 and the collecting mirror 22 can be rotated independent from rotation of the thruster 2. This is an example of complementary articulation attachments, which can coincide with or enable offsetting or compensating articulation movements that can be controlled to occur simultaneously so that an initial alignment (e.g., of a thruster in a desired propulsion direction) can be maintained.

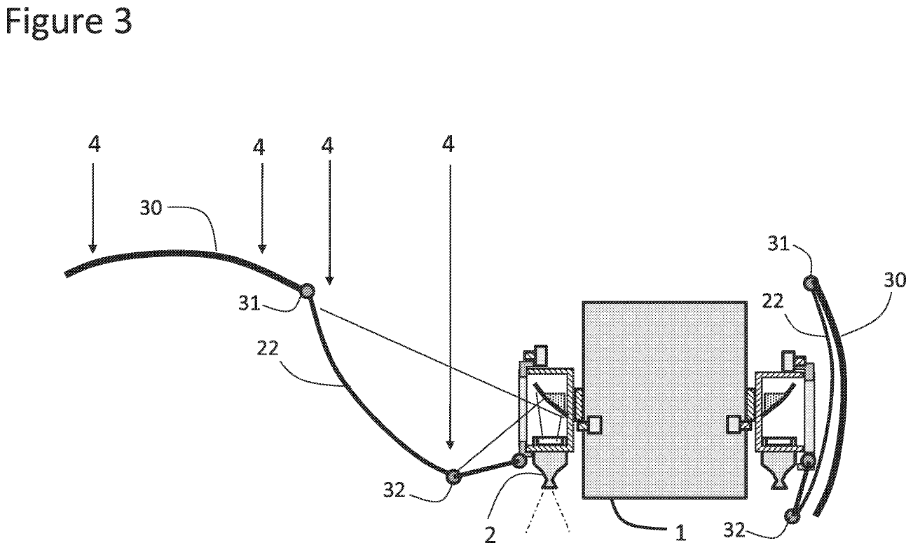

Referring to the left side of FIG. 3, a photovoltaic solar cell panel 30 is shown in this embodiment as moderately curved. In other embodiments the panel 30 may be flat or some other desirable shape. Panel 30 is attached to the outer edge of collecting mirror 22 through hinge 31. As the mirror 22 may be rotated to maintain alignment with the Sun, so the panel 30 may also be aligned toward the Sun. In this manner a thruster 2, solar collecting mirror 22, and a solar cell panel 30 may be connected to a single outer surface of the spacecraft bus 1 and alignment can be complementary or concurrent. Alternatively, a controller can adjust hinges 31 and 32 (or similar articulation joints) to achieve independent alignment movements.

The right side of FIG. 3 illustrates how the mirror 22 and solar panel 30 may be compactly folded (e.g., for launch or storage), which can be useful to fit the structures within the limited spatial volume of a booster rocket nose cone. It can be seen that panel 30 may be curved to fit compactly against the non-reflective side of mirror 22.

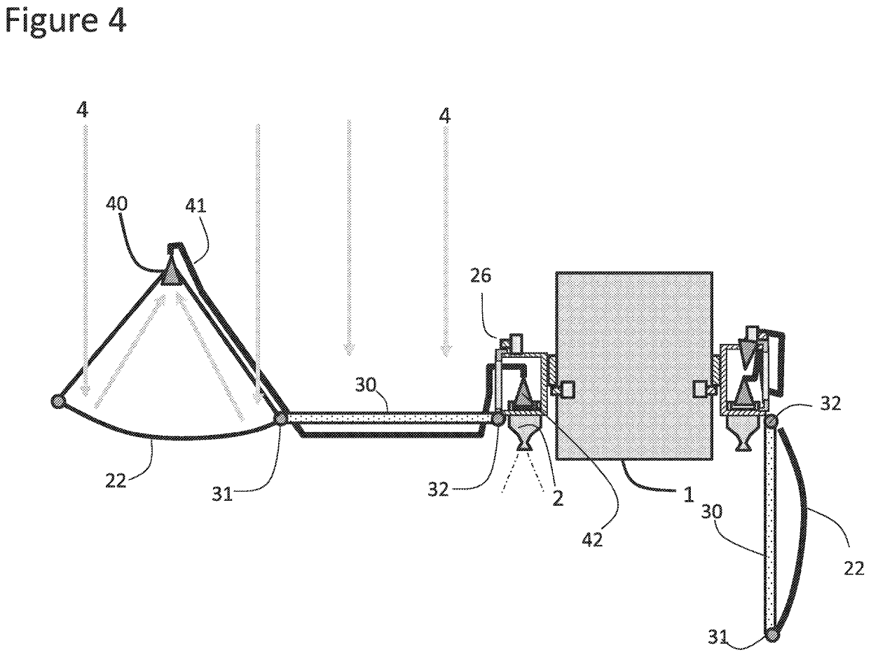

Referring to FIG. 4, a solar energy collecting mirror 22 focuses a powerful beam of solar energy onto the entrance aperture 40 of a bundle of optical fibers 41. Entrance aperture 40 can be a conical assembly of glass or hollow reflecting surfaces designed to efficiently couple the converging solar energy beam into the acceptance angle of the optical fiber bundle 41. In certain advantageous embodiments, the sides of the cone are not straight but curved surfaces. A similar coupling assembly 42 receives concentrated solar energy from the output end of the optical fiber bundle and couples the energy into a solar thermal thruster 2.

The use of optical fibers to conduct concentrated solar energy allows considerable design freedom in the placement of large solar collectors 22. In the embodiment illustrated in FIG. 4, the solar collector has been attached outboard of a solar cell array 30. The solar cell array 30 may be a flat array rather than curved as in FIG. 3, since for example it may not need to conform to the solar collector 22 when folded for launch.

The right side of the FIG. 4 illustrates how the solar cell array and solar collector may be folded through articulation features (e.g., hinges 31 and 32) into a compact form (e.g., for launch or storage), which can be useful to fit the structures within the nose cone of a booster rocket.

It is to be understood that not necessarily all objects or advantages may be achieved in accordance with any particular embodiment described herein. Certain embodiments may be configured to operate in a manner that achieves or optimizes one advantage or group of advantages as taught herein without necessarily achieving other objects or advantages as may be taught or suggested herein.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language used herein, such as, among others, “can,” “might,” “may,” “e.g.,” “for example,” and the like, unless specifically stated otherwise, or otherwise understood within the context as used, is generally intended to convey that certain embodiments include, while other embodiments do not include, certain features, elements, or states. Thus, such conditional language is not generally intended to imply that features, elements or states are in any way required for one or more embodiments.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Such disjunctive language is not generally intended to, and should not, imply that certain embodiments require at least one of X, at least one of Y, and at least one of Z to each be present. Thus, the term “or” is used in its inclusive sense (and not in its exclusive sense) so that when used, for example, to connect a list of elements, the term “or” means one, some, or all of the elements in the list.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The terms “comprising,” “including,” “having,” and the like are synonymous and are used inclusively, in an open-ended fashion, and do not exclude additional elements, features, acts, operations, and so forth.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others.

What is claimed is:

1. A method of launching a spacecraft designed for free-flight in space, the method comprising:
launching the spacecraft from Earth on a rocket, wherein the spacecraft is folded into a package in order to fit within an aerodynamic nose fairing atop the rocket during launch;
after arriving at a suitable orbit, detaching the spacecraft from the rocket; and
unfolding the spacecraft and deploying a solar energy collecting mirror, photovoltaic arrays, antennas, and thermal radiators.

2. The method of claim 1, further comprising:
rotating a rocket thruster and the solar energy collecting mirror of the spacecraft along a common rotation axis.

3. The method of claim 2, further comprising:
collecting and focusing sunlight from the solar energy collecting mirror into a concentrated solar energy beam;
directing the concentrated solar energy beam along the common rotation axis and into the rocket thruster as the rocket thruster rotates relative to the spacecraft bus and relative to the pointing direction of the solar energy collecting mirror.

4. The method of claim 2, further comprising:
receiving concentrated solar energy at a flexible bundle of optical fibers; and
conducting the solar energy via the flexible bundle of optical fibers into the rocket thruster independent of a relative rotation angle between the solar energy collecting mirror and a pointing direction of the rocket thruster.

5. A spacecraft comprising:
a spacecraft bus;
a rocket thruster; and
a solar energy collecting mirror,
wherein the rocket thruster is configured to rotate along a common rotation axis which in turn is attached to a single location on an outer surface of the spacecraft bus.

6. The spacecraft of claim 2 further comprising:
a photovoltaic panel connected to the rocket thruster and the solar energy collecting mirror,
wherein the photovoltaic panel and the solar energy collecting mirror are configured to rotate along the common rotation axis with the rocket thruster.

7. The spacecraft of claim 3 where elements of the solar energy collecting mirror, the photovoltaic panel, the rocket thruster, and the common rotation axis mechanisms are configured to be compactly folded together during launch operations and unfolded during spacecraft free flight operations.

8. The spacecraft of claim 3 where the rocket thruster, the solar energy collector, and the photovoltaic panel are configured to be actuated by one or more independently controlled rotation motors which allow independent rotation of one or more of the connected elements about the common rotation axis.

9. The spacecraft of claim 3 further comprising:
a second rocket thruster;
a second solar energy collecting mirror; and
a second photovoltaic panel,
wherein the second rocket thruster, the second solar energy collecting mirror, and the second photovoltaic panel are attached to a second single location on the outer surface of the spacecraft bus.

10. The spacecraft or claim 3 where the rocket thruster comprises a solar thermal rocket and where the solar energy collecting mirror is configured to capture heat energy to power the rocket thruster from sunlight.

11. The spacecraft of claim 7 further comprising:
one or more curved mirrors or lenses configured to collect and focus sunlight from the solar energy collecting mirror into a concentrated solar energy beam which is directed along the common rotation axis and into the rocket thruster as the rocket thruster rotates relative to the spacecraft bus and relative to the pointing direction of the solar energy collecting mirror.

12. The spacecraft of claim 7 further comprising:
a flexible bundle of optical fibers configured to receive concentrated solar energy and conduct the solar energy into the rocket thruster independent of a relative rotation angle between the solar energy collecting mirror and a pointing direction of the rocket thruster.
